(19) United States
(12) Patent Application Publication
(10) Pub. No.: US 2006/0240152 A1
(43) Pub. Date: Oct. 26, 2006

(54) Graphical indicator for determining an amount of a nutrional element consumed, removed, or remaining in a package

(76) Inventor: Michael Krawzsenek, Austin, TX (US)

Correspondence Address: Michael R. Krawzsenek, 5300 Bluestar Drive, Austin, TX, 78739, US

(21) Appl. No.: 11/110,284

(22) Filed: Apr. 20, 2005

(51) Int. Cl. A22C 17/10

(52) U.S. Cl. 426/87

(57) ABSTRACT

A food package and methods for its use. The package includes a food having a nutritional element and a graphical indicator including a graduated sequence of marks, including a first mark displaying an amount of the nutritional element in the food package when the food is level with the first mark and at least a second mark displaying a decreasing amount of the nutritional element in the food package when the food is level with the second mark.

### BACKGROUND OF THE INVENTION

1. Field of the Invention

The present invention concerns packages comprising a graphical indicator. The graphical indicator can be used to determine the amount of a nutritional element remaining, removed, or consumed from a package.

2. Description of Related Art

Current methods of determining the amount of a nutritional element remaining, consumed, or removed in a package can be inaccurate or cumbersome. For example, most food packages include a table that describes the nutritional facts. Such a table usually identifies the number of servings per container and the amount of a nutritional element per serving. In order to determine the amount of a nutritional element consumed from the package, for example, a person typically has to: (1) guess how much food was consumed; (2) determine how many servings is in the consumed food; and (3) compare the servings consumed with the amount of the nutritional element in a serving. This determination relies on guesses and is often inaccurate and cumbersome. The use of a calculator is often required.

Another method requires the use of a weigh scale. This typically requires weighing the food prior to consumption. This can be cumbersome and requires an extra piece of equipment (i.e., a weigh scale). Determining the amount a nutritional element remaining in a package is also difficult and usually requires removal of the food from the package and then weighing the food.

### SUMMARY OF THE INVENTION

The present invention overcomes certain deficiencies in the art by providing a simple and accurate way to determine the amount of a nutritional element remaining, removed, or consumed from a package. In certain aspects, there is no need for an extra piece of equipment or a calculator to make this determination.

In one non-limiting aspect of the present invention, there is disclosed a package comprising food, the food comprising a nutritional element, and a graphical indicator, the graphical indicator comprising a graduated sequence of marks comprising a first mark displaying an amount of the nutritional element in the package when food in the package is level with the first mark and at least a second mark displaying a decreasing amount of the nutritional element in the package when the food in the package is level with the second mark. The package can further include indicia identifying the nutritional element. In non-limiting aspects, the indicia can be a word, an abbreviation, a picture, or a symbol. The indicia can be on or can be part of the package or the graphical indicator. The indicia can be next to, near or away from the graphical indicator in other non-limiting aspects. The first mark can display a total amount of the nutritional element in the package. The graphical indicator can include a third mark displaying a decreasing amount of the nutritional element in the food package when compared to the second mark. In other aspects, there can be 4, 5, 6, 7, 8, 9, 10, 11, 12, 13, 14, 15, 16, 17, 18, 19, 20, or more marks, each mark displaying a decreasing amount of the nutritional element in the food package when compared to the previous mark. In certain embodiments, the graphical indicator includes a mark displaying the number 0. The number zero can indicate that no nutritional element remains in the package when the food in the package is level with the mark displaying the number 0. The mark displaying the number 0 can be at a top, middle, or bottom portion of the package. In certain aspects, the number 0 is at the bottom portion of the package. In non-limiting aspects, the first mark of the graphical indicator can be at a bottom, middle, or top portion of the package. In certain embodiments, the first mark is at a top portion of the package. In other non-limiting aspects, the graduated sequence of marks can begin with the first mark and end with a final mark, the first mark displaying the total amount of nutritional element in the package and the final mark displaying the number 0.

In another non-limiting aspect of the present invention, there is provided a package comprising food, the food comprising a nutritional element, and a graphical indicator comprising a graduated sequence of marks comprising (i) a first mark displaying an amount of a nutritional element consumed or removed from the food package when the food in the package is level with the first mark and (ii) at least a second mark displaying an increasing amount of the nutritional consumed or removed from the package when the food in the package is level with the second mark. The package can further include indicia identifying the nutritional element. In non-limiting aspects, the indicia can be a word, an abbreviation, a picture, or a symbol. The indicia can be on the package or the graphical indicator. The indicia can be next to, near or away from the graphical indicator in other non-limiting aspects. The second mark of the graphical indicator can display a total amount of the nutritional element in the package. In other aspects, the graphical indicator includes a third mark displaying an increasing amount of the nutritional element consumed or removed from the food package when compared to the second mark. The graphical indicator can include, in non-limiting aspects, a mark displaying the number 0. The number 0 can indicate that no nutritional element has been consumed or removed from the package when the food in the package is level with the mark displaying the number 0. The mark displaying the number 0 can be at a top, middle, or bottom portion of the food package. In certain aspects, the mark displaying the number 0 is at a top portion of the package. In yet another non-limiting aspect, the first mark can be at a top, middle, or bottom portion of the food package and the second mark can at a bottom, middle, or top portion of the food package. The graduated sequence of marks can begin with a mark displaying the number 0 and end with a final mark, the final mark displaying the total amount of the nutritional element consumed or removed from the food package.

There is also disclosed a method for determining an amount of a nutritional element remaining, removed, or consumed in a package of the present invention. The method includes determining the level of contents in the package in relation to a mark of the graphical indicator, the mark indicating the amount of the nutritional element remaining, removed, or consumed in the package. The method can be performed prior to removing or consuming contents of the package. In other aspects, the method can be performed after some or all of the contents have been removed or consumed from the package. In non-limiting embodiments, the method can further include determining the amount of the nutritional element consumed or removed from the package by: (i) determining the level of contents in the package in relation to the first mark prior to consuming or removing the contents; (ii) determining the level of contents in the package in relation to the second mark after consuming or removing the contents; and (iii) subtracting the amount of the nutritional element displayed by the first mark with the amount of the nutritional element displayed by the second mark, wherein the remaining amount is the amount of the nutritional element consumed or removed from the package. Contents of the package can be a food. Non-limiting examples of food include food known to those of skill in the art and food discussed throughout this document.

The graphical indicator can extend across at least 5, 10, 15, 20, 25, 30, 35, 40, 45, 50, 55, 60, 65, 70, 75, 80, 85, 90, 95%, or more of a surface of the food package. In certain aspects, the graphical indicator can extend across an entire surface of a food package. It should be recognized that packages comprising food are not always completely full. It is contemplated that the graduated sequence of marks of the graphical indicators can begin at a level of the food in the package, and not simply at the top of the package. It is also contemplated that a graphical indicator can begin and/or end at a top, middle, or bottom portion of the package, regardless of the level of the food in an opened or unopened package.

In other non-limiting embodiments, the mark(s) of the graphical indicator can include a symbol or numerical value (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 105, 110, 115, 120, 125, 130, 135, 140, 145, 150, 155, 160, 165, 170, 175, 180, 185, 190, 195, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 50, 520, 540, 560, 580, 600, 620, 640, 660, 680, 700, 720, 740, 760, 780, 800, 820, 840, 860, 880, 900, 920, 940, 960, 980, 1000, 1100, 1200, 1300, 1400, 1500, 1600, 1700, 1800, 1900, 2000, etc.). The mark(s) can include a unit of measurement or its corresponding abbreviation (non-limiting examples include e.g., gram/g, milligram/mg, kilogram/kg, microgram/mcg or μg, milliliter/ml, liter/l, unit/U, international unit/IU, cubic centimeter/cc, or millequivalent/mEq).

In other non-limiting embodiments, the nutritional element can be a calorie, protein, carbohydrate, fat, salt, sodium, sugar, fiber, vitamin (e.g., D, E, A, K, C, B vitamins (including biotin, choline, folic acid, inositol, PABA (para-aminobenzoic acid), B-1 (thiamin), B-2 (riboflavin), B-3 (niacin), B-5 (pantothenic acid), B-6 (pyridoxine), B-12 (cobalamin) etc.), mineral (e.g., calcium, magnesium, iron, phosphorus, potassium, zinc, selenium, copper, manganese, chromium, potassium, lycopene, etc.), fortified or flavored water, amino acid, creatine, or creatine phosphate. These nutritional elements are exemplary only, and it is contemplated that other nutritional elements known in the art can be used with the present invention.

In certain non-limiting aspects, the graphical indicator can be placed, adhered to, or stamped on the surface of the package. In other aspects, the graphical indicator can be incorporated into or manufactured as part of the package. The package, in non-limiting aspects, may be a can (e.g., soda, soup can, diet shake can (e.g., SLIM FAST™, ENSURE™, WEIGHT WATCHERS™ or any type and/or shape of can that may hold a solid or liquid food). Non-limiting examples of a can include 6, 7, 8, 9, 10, 11, 12, 13, 14, 15, 16, 17, 18, 19, 20, 21, 22, 23, 24, 25, 26, 27, 28, 29, 30, 31, 32, 44, or 64 ounce or 1, 2, 3, 4, 5, 6, 7, 8, 9 or more liter can, etc.). In other non-limiting embodiments, the package may be a bottle (e.g., glass or plastic bottle or any type of bottle that may hold a solid or liquid food). The bottle in certain non-limiting embodiments is a 6, 7, 8, 9, 10, 11, 12, 13, 14, 15, 16, 17, 18, 19, 20, 21, 22, 23, 24, 25, 26, 27, 28, 29, 30, 31, 32, 44, or 64 ounce or 1, 2, 3, 4, 5, 6, 7, 8, 9 or more liter bottle, etc. Other non-limiting packages include a carton, a wrapper (e.g., candy wrapper, shrink-wrapped food products wherein the graphical indicator is placed, stamped, or adhered to the shrink-wrap), a box (all size and shapes of boxes are contemplated), a bag (non limiting examples such as chip bags, popcorn bags, candy bags, flour bags, sugar bags, IV bags, etc.) or a cup (non-limiting examples include coffee cups, mugs, Styrofoam cups, cardboard cups, paper cups, etc.). In other non-limiting aspects, the package is transparent, partially transparent, or opaque. In other aspects, the package is not an IV bag. The above packages are exemplary only, and it is contemplated that any type of package that can hold food can be used with the present invention.

In other non-limiting embodiments, the food can be any type of food that includes a nutritional element. The food can be in a liquid form, a non-liquid form, or a solid form (non-limiting examples include granules, powder, or the shape that any type of food product has). Non limiting examples of food can be soda, juice, smoothie, coffee, tea, shake, soup, meat (e.g., poultry, beef, pork, fish, lamb, deer, sea food, etc.), candy, cookies, mixes, etc.). Again, it is contemplated that any type of food described in this document or known to those of skill in the art can be used with all of the apparatuses and methods of the present invention.

The graphical indicator, in other embodiments, can be displayed in a holographic form or on an electronic screen or display (e.g., an LCD screen). In certain aspects, the hologram or electronic screen or display can include one, two, three, four, five, six, seven, eight, nine, ten, or more graphical indicators. For example, the graphical indicators can display different types of nutritional elements. In one aspect, a first graphical indicator can display calories, a second graphical indicator can display protein, a third graphical indicator can display carbohydrates, a fourth graphical indicator can display sodium, a fifth graphical indicator can display fat, etc.

Similarly, the packages can include one, two, three, four, five, six, seven, eight, nine, ten, or more graphical indicators. These indicators can display all type of different nutritional elements discussed in this document and known to those of ordinary skill in the art.

The package can also include at least a transparent portion. In certain non-limiting aspects, the graphical indicator includes a transparent portion. The transparent portion of the package can be helpful in determining the level of the food in the food package in relation to a mark on the graphical indicator. It should be recognized, however, that a transparent portion of the package is not needed or required. A person can determine the level of food in the package in relation to a mark on the graphical indicator by shaking or moving the package, looking into the package, or by simply estimating the level of food in the package. All forms of determining the level of the food in the package are contemplated as being useful with the present invention.

In other non-limiting aspects, the graphical indicator or the package can include indicia that identify the nutritional element. As noted above, non-limiting examples of indicia include words, abbreviations, pictures, or symbols. By way of example only, the word can be “calories,” “carbohydrates,” “protein,” “salt,” sodium,” “fat,” or “fiber.” It should be recognized that any type of word mentioned in this document or known to those of skill in the art that can be used to describe a nutritional element is contemplated as being useful with the present invention. Similarly, the symbol or picture can identify any of the nutritional elements disclosed in this document and known to those of ordinary skill in the art.

An additional non-limiting embodiment of the present invention includes a graphical indicator of the present invention included on a structure. The structure can be configured to wrap around or encase the food package. By way of example only, the graphical indicator can be placed on a “coozie” or “koozie.” A “coozie” is an insulated wrap that can hold a can or bottle. Coozies are typically made of neophrene or styrophome.

The word “portion” as that word is used with “top,” “middle,” or “bottom,” means within the top, middle, or bottom 20% of the package, more preferably, within the top, middle, or bottom 10%, and most preferably within the top, middle, or bottom 5% of the package.

The word, “a” or “an” may mean one or more, unless clearly indicated otherwise. As used in the specification and the claim(s), when used in conjunction with the word “comprising,” “including,” “containing,” or “having,” or any variation of these terms, the words “a” or “an” may mean one or more than one. Similarly, the word “another” may mean at least a second or more.

It is contemplated that any apparatus discussed in this specification can be implemented with respect to any method of the invention, and vice versa.

The term “about” is used to indicate that a value includes the inherent variation of error for the device or the method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “has” and “have”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and figures, while indicating specific embodiments of the invention are given by way of illustration only. Various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain non-limiting aspects of the present invention. The invention may be better understood by reference to one or more of these drawings in combination with the detailed description of specific embodiments presented.

FIG. 1 represents a front view of a can comprising a graphical indicator that can be used to determine the amount of calories remaining in the can, in accordance with embodiments of this disclosure.

FIG. 2 represents a front view of a can comprising a graphical indicator that can be used to determine the amount of calories removed or consumed from the can, in accordance with embodiments of this disclosure.

FIG. 3 represents a front view of a bag comprising a graphical indicator that can be used to determine the amount of carbohydrates remaining in the bag, in accordance with embodiments of this disclosure.

FIG. 4 represents a front view of a bag comprising a graphical indicator that can be used to determine the amount of carbohydrates removed or consumed from the bag, in accordance with embodiments of this disclosure.

FIG. 5 represents a front view of a cup comprising a graphical indicator that can be used to determine the amount of protein removed or consumed from the cup, in accordance with embodiments of this disclosure.

FIG. 6 represents a front view of a box comprising a graphical indicator that can be used to determine the amount of sodium remaining in the box, in accordance with embodiments of this disclosure.

### DETAILED DESCRIPTION OF THE INVENTION

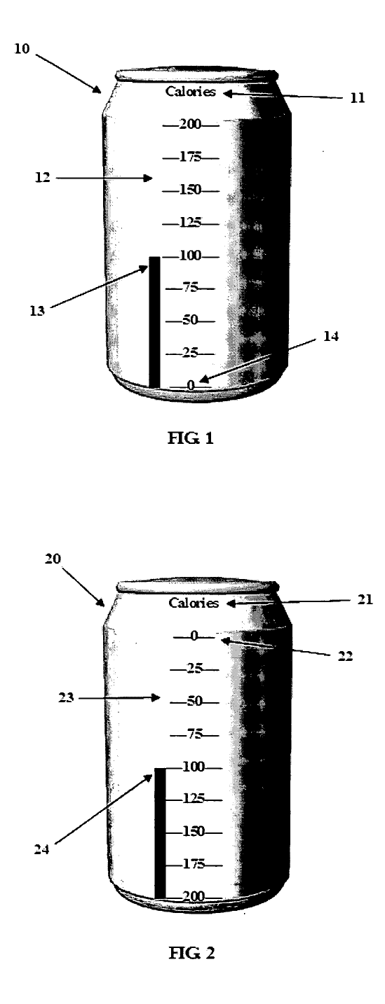

FIG. 1 represents a side view of a non-limiting package according to one embodiment of t the present disclosure. The package in this figure is a twelve-ounce can 10. The can includes a graphical indicator comprising a graduated sequence of marks 14. The graduated sequence of marks 14 includes a first mark (“—200—”) that displays an amount of a nutritional element in the can 10 when the liquid 13 in the can 10 is level with the first mark. The graphical indicator also includes several other marks, each mark gradually displaying a decreasing amount of the nutritional element remaining in the can 12 when liquid 13 in the can 10 is level with a given mark. By way of example only, the mark indicated by “—100—” indicates that 100 calories remain in the can 10 when liquid 13 is level with this mark. The mark 14 indicates that 0 calories remain in the can 10. The first mark (“—200—”) indicates the total amount of calories in the can 10 when liquid 13 is level with that mark.

The can 10 also includes a word 11. As noted throughout this document, however, the word can identify any nutritional element in the can 10. In this non-limiting embodiment, the word 11 is “Calories.” Therefore, the graphical indicator can be used to determine the total amount of calories remaining in the can 10 at any given time by comparing the level of the liquid 13 in the can 10 in relation to a mark on the graphical indicator. Additionally, a user can determine the amount of calories consumed or removed from the can 10 by subtracting 200 from 100 to determine the amount of calories removed or consumed from the can 10.

The can 10 in FIG. 1 also includes a transparent portion 12. This can be used to determine the amount of liquid 13 in the can 10. The transparent portion 12 can be part of the graphical indicator or part of the can 10. In either event, it is preferred, but not required, to have the transparent portion 12 near or next to the graphical indicator. In other embodiments, however, the can 10 does not need to have a transparent portion 12. A user can determine the level of a liquid 13 in the can 10 in relation to any mark of the graphical indicator by simply shaking, moving, or visually inspecting the level of the liquid 13 in the can 10.

FIG. 2 represents a side view of a non-limiting package according to one embodiment of the disclosure. The package is a twelve-ounce can 20. In this figure, the graphical indicator includes a graduated sequence of marks comprising a first mark 22 displaying an amount of a nutritional element consumed or removed from the can 20 when liquid 24 in the can 20 is level with the first mark 22. There is also at least a second mark that displays an increasing amount of the nutritional consumed or removed from the can 20 when the liquid 24 in the can 20 is level with the second mark. There can be several marks on this can 20, each mark displaying an increasing amount of the nutritional element consumed or removed from the can 20. In this non-limiting embodiment, the mark represented by “—200—” represents the total amount of the nutritional element in the can and the total amount of nutritional element consumed or removed from the can 20. The mark 22 in FIG. 2 indicates that no nutritional element has been removed or consumed from the can 20 when liquid 24 in the can 20 is level with that mark 22.

The can 20 also includes a word 21 in this embodiment. The word 21 is “Calories.” As noted throughout this document, however, the word, if present, can identify any nutritional element in the can 20. In this non-limiting embodiment, the graphical indicator can be used to determine the total amount of calories removed or consumed from the can 20 at any given time by comparing the level of the liquid 24 in the can 20 in relation to a mark on the graphical indicator. Additionally, a user can determine the amount of calories remaining in the can 20 by subtracting the bottom mark (i.e., —200—) from any mark that corresponds to the level of liquid 24 in the can. For example, the user would subtract 200 from 100 in FIG. 2 to determine that the amount of calories remaining in the can 20 is 100.

The can 20 in FIG. 2 also includes a transparent portion 23. As described in FIG. 1 above, the transparent portion can be useful, but is not required, to determine the level of the liquid 24 in the can 20 at any given time.

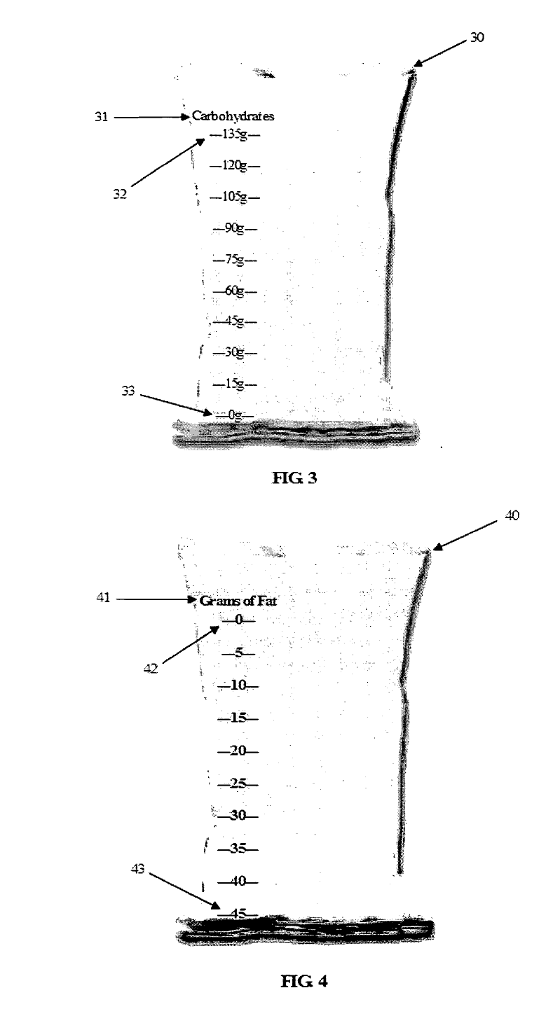

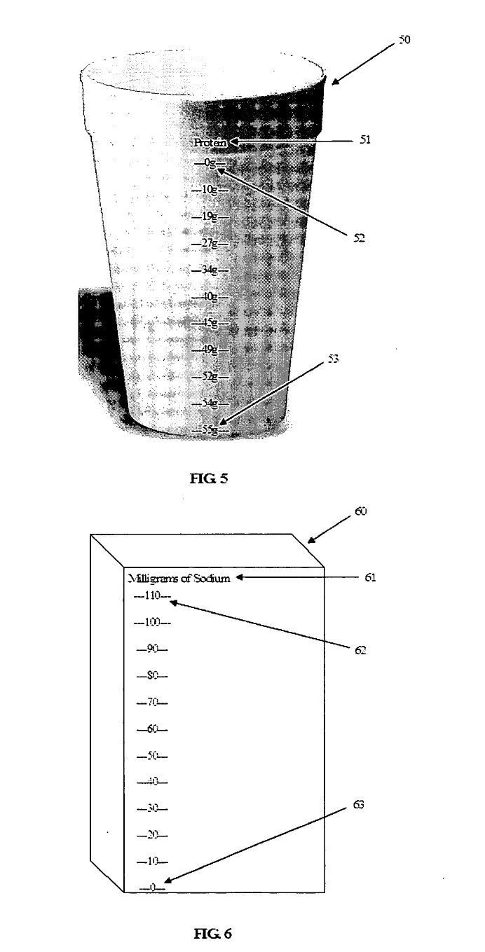

The remaining figures include additional non-limiting embodiments of the present disclosure. For example, FIGS. 3 and 4 represent a front view of a bag 30 or 40, respectively. The graphical indicator in FIG. 3 can be used to determine the amount of carbohydrates remaining in the bag 30. The graphical indicator in FIG. 4 can be used to determine the amount of a carbohydrate removed or consumed from the bag 40. FIG. 5 represents a front view of a cup 50 comprising a graphical indicator. The graphical indicator in FIG. 5 can be used to determine the amount of protein removed or consumed from the cup 50. FIG. 6 represents a front view of a box 60 comprising a graphical indicator that can be used to determine the amount of sodium remaining in the box 60.

The marks and words displayed in all figures described above are examples only. It is contemplated that the marks can take a variety of shapes, sizes, or other means (e.g. symbols, words, letters, numerals, pictures, or illustrations, to name a few) that can be used to determine an amount of a nutritional element remaining, removed, or consumed from the package.

As noted above, it is also contemplated that the packages can include multiple (e.g., one, two, three, four, five, six, seven, eight, nine, ten, or more graphical indicators). These indicators can display all type of different nutritional elements discussed in this document and known to those of ordinary skill in the art.

While the techniques disclosed have been described in terms of specific embodiments, these embodiments are non-limiting. Additionally, it will be apparent to those of skill in the art that variations may be applied without departing from the scope and spirit of the invention. All such similar modifications apparent to those skilled in the art are deemed to be within the scope of the invention, which is defined by the claims and their equivalents.

1. A package including:
a food having a nutritional element;
a graphical indicator including a graduated sequence of marks having:
(i) a first mark displaying an amount of the nutritional element in the package when the food is level with the first mark; and
(ii) a second mark displaying a decreasing amount of the nutritional element in the package when the food is level with the second mark; and
an indicia identifying the nutritional element.

2. The package of claim 1, wherein the first mark displays the total amount of the nutritional element in the food package.

3. The package of claim 1, further including a third mark displaying a decreasing amount of the nutritional element in the package when compared to the second mark.

4. The package of claim 1, wherein the graphical indicator extends across at least 50%, 75%, or 90% of the package.

5. The package of claim 1, wherein the nutritional element is selected from the group consisting of a calorie, a protein, a carbohydrate, a fat, a salt, a fiber, and a vitamin.

6. The package of claim 1, wherein the package is a can, bottle, bag, cup, wrapper, or box.

7. The package of claim 1, wherein the food is a liquid.

8. The package of claim 1, further including a hologram or an electronic screen or display that displays the graphical indicator.

9. The package of claim 1, wherein the indicia is a word or abbreviation.

10. The package of claim 9, wherein the indicia is a word and the word is calories, protein, carbohydrates, sodium, fiber, vitamin, or fat.

11. The package of claim 1, wherein a portion of the food package including the graphical indicator is transparent.

12. A package including:
a food having a nutritional element;
a graphical indicator including a graduated sequence of marks having:
(i) a first mark displaying an amount of a nutritional element consumed or removed from the package when the food is level with the first mark; and
(ii) at least a second mark displaying an increasing amount of the nutritional element consumed or removed from the package when the food is level with the second mark; and
an indicia identifying the nutritional element.

13. The package of claim 12, further including a third mark displaying an increasing amount of the nutritional element consumed or removed from the package when compared to the second mark.

14. The package of claim 12, wherein the graduated sequence of marks begins with a mark displaying the number 0 and ends with a final mark, the final mark displaying the total amount of the nutritional element in the package.

15. The package of claim 12, wherein the nutritional element is selected from the group consisting of a calorie, a protein, a carbohydrate, a fat, a salt, a sugar, a fiber, and a vitamin.

16. The package of claim 12, wherein the package is a can, bottle, bag, wrapper, cup, or box.

17. The package of claim 12, wherein the package further includes a second graphical indicator.

18. The package of claim 12, wherein the indicia is a word or abbreviation.

19. The package of claim 18, wherein the indicia is a word and the word is calories, protein, carbohydrates, sodium, fiber, vitamin, or fat.

20. A method for determining an amount of a nutritional element remaining, consumed, or removed from a package, the method including determining the level of food in the package in relation to a mark of a graphical indicator, the mark identifying the amount of the nutritional element remaining, consumed, or removed from the package.
